(19) United States
(12) Patent Application Publication
(10) Pub. No.: US 2004/0144188 A1
(43) Pub. Date: Jul. 29, 2004

(54) Internal vibrator for concrete compacting

(76) Inventor: Michael Steffen, Munchen (DE)

Correspondence Address: Timothy E Newholm, Boyle Frederickson Newholm Stein & Gratz, 250 Plaza, Suite 1030, 250 East Wisconsin Avenue, Milwaukee, WI, 53202, US

(21) Appl. No.: 10/476,516

(22) PCT Filed: May 17, 2002
(86) PCT No.: PCT/EP02/05107

(30) Foreign Application Priority Data
May 17, 2001 (DE) 101 24 145.3

(51) Int. Cl. F16H 33/10

(52) U.S. Cl. 74/86

(57) ABSTRACT

The invention relates to an internal combustion vibrator for compacting concrete, comprising a vibrator housing in which a rotational unbalance mass, an electric motor powering said unbalance mass and part of a power line connected to the electric motor for supplying power to said electric motor are integrated. The internal vibrator also comprises an interrupter interconnected in the power line for interrupting power supply of the electric motor. Due to the fact that the interrupter is configured in an electrically controllable manner, power supply of the electric motor can be precisely controlled by a plurality of signal transmitters.

The present invention relates to an internal vibrator for concrete compacting.

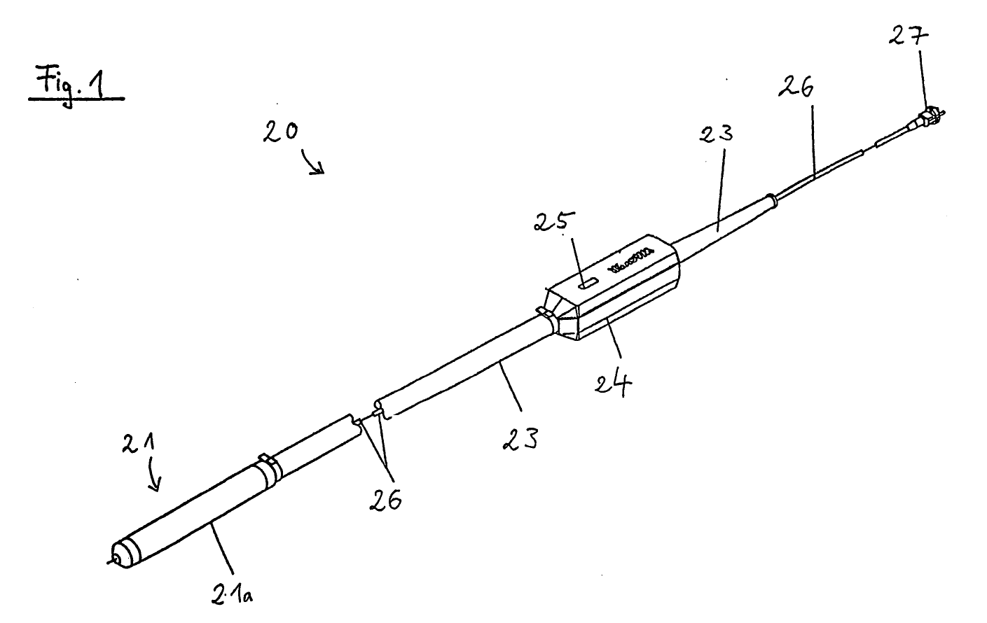

Internal vibrators for the compacting of concrete are known, and have been used on construction sites for many years. FIG. 1 shows a specific embodiment, known from DE-U-92 17 854.5, of an internal vibrator whose design and manner of functioning are briefly explained:

An internal vibrator 20 has a vibrator bottle 21, a protective and operating tube 23, a mounting unit 24, integrated into protective and operating tube 23, for accommodating a converter (not shown) and an operating switch 25, a power lead in the form of a power supply cable 26, and a power plug 27.

Vibrator bottle 21 comprises a vibrator housing 21a, an electric motor (not visible in the drawing) that is built into the vibrator housing, and an imbalance mass (not shown) that is likewise situated in vibrator housing 21a and that can be set into rotation about a longitudinal axis of vibrator bottle 21 by the electric motor. The converter integrated in installation unit 24 produces the current, having a frequency higher than the power line frequency, that is required to drive the electric motor, and that is supplied to the electric motor via power supply cable 26 integrated into protective and operating tube 23. The supply of power can be controlled by operating switch 25.

Internal vibrators of the type described above heat up very strongly during operation, in particular in the area of vibrator bottle 21, due to the heat released by the electric motor integrated therein, as well as due to bearing friction. This does not present a problem if during operation the vibrator bottle 21 is surrounded by liquid concrete, because the heat produced in vibrator bottle 21 can be emitted very effectively to the surrounding environment due to the high thermal conductivity of the concrete, or of the water contained in the liquid concrete. However, if vibrator bottle 21 is removed from the concrete during operation, the heat produced can no longer be transported away rapidly enough, due to the low thermal conductivity of air. The risk of overheating of the internal vibrator 20, or of the electric motor, thus arises.

In order to prevent a possible overheating of the electric motor, it is known to integrate a temperature fuse into vibrator bottle 21 or into vibrator housing 21a in the immediate vicinity of the electric motor or in the electric motor. The temperature fuse interrupts the power supply to the electric motor if the temperature thereof exceeds a predetermined threshold value. In this way, the electric motor is simultaneously also protected against overheating that can arise due to defective mechanical construction of, or a defective feed voltage to, the electric motor.

Standardly, the temperature fuse is realized in the form of a plurality of bimetallic switches. Here, a separate bimetallic switch is preferably integrated in the winding head of the motor in each conductor of power supply cable 26; each such switch changes its switching state at a determined temperature, thus interrupting the supply of power.

Because, due to production tolerances, the bimetallic switches can easily comprise different temperature switching points, and because in addition non-homogenous temperature fields can prevail inside the vibrator bottle, as a rule the bimetallic switches change their switching state at different points in time. However, this has the result that the electric motor is exposed to high current loads in the switched-off phase of the bimetallic switches. The high current loading can in addition rapidly lead to scaling of the bimetallic switches. In the worst case, the scaling can result in the total failure of the bimetallic switches, and thus of the internal vibrator. A further disadvantage is that when the electric motor is switched on again by the bimetallic switches after a cooling-off phase, the electric motor is again exposed to a strong current loading, because here as well the bimetallic switches do not switch at exactly the same point in time. This can have the result that the additionally-heated electric motor very rapidly again reaches the temperature threshold value, and is again switched off by the bimetallic switches within a very short time.

The temperature fuse on the basis of bimetallic switches has the additional disadvantage that the bimetallic switches often briefly open or close due to the strong vibration produced by the electric motor and the imbalance. The current loading to the electric motor connected with this can result in wear of the electric motor, or in the destruction of drive electronics connected thereto.

In order to manufacture the vibrator bottle, standardly the electric motor, the bimetallic switches, and the power lead are cast to form a common unit by means of a suitable material. The high pressures that thereby occur can lead, due to the mechanical forces, to the failure of the bimetallic switches or to an undesirable shifting of the respective temperature switching points.

The underlying object of the present invention is to indicate an internal vibrator for concrete compacting in which the electric motor is effectively protected against overheating.

According to the present invention, this object is achieved by an internal vibrator having the features of patent claim 1. Advantageous constructions and developments of the basic idea of the invention are explained in the following description, and/or are defined in subclaims.

The internal vibrator according to the present invention comprises a vibrator housing in which there are integrated a rotatable imbalance mass, an electric motor that drives the imbalance mass, and a part of a power lead connected with the electric motor for supplying power to the electric motor. In addition, the internal vibrator comprises an electrically controllable interrupter that is inserted into the power lead, for the interruption of the power supply to the electric motor. Here it is essential that the interrupter is integrated into the vibrator housing. The electrically controllable construction of the interrupter makes it possible to control the interrupter in a chronologically precise manner by means of electrical interrupt signals. If the interrupter (e.g. in order to control various current phases) consists of a plurality of interrupter subunits that are independent of one another, these can be switched at exactly the same point in time using respective interrupt signals. For this purpose, the interrupt signals are produced in such a way, and are supplied to the interrupter subunits in such a way, that the interrupter subunits simultaneously receive the respective interrupt signals. In this way, undesirable two-phase operation can be avoided during the switching on and off of the electric motor.

The interrupter preferably comprises at least one triac, whereby in each current conductor or (according to the application) in a part of the current conductor of the power lead, a separate interrupter subunit can be inserted in the form of a triac that can respectively be controlled or switched by a corresponding interrupt signal. The controlling of the triac using respective electrical interrupt signals enables a switching of the triac at exactly the same point in time. Of course, instead of the triac it is also possible to use other electronic switching elements, such as transistors or thyristors.

The electrically controllable construction of the interrupter makes it possible, as will become clear below, to use this interrupter both as a component of a temperature fuse and also for the general switching on and off of the internal vibrator. In this way, it is possible to do without a current interrupt point, normally provided separately in known internal vibrators, for the switching on and off of the internal vibrator, in that according to the present invention this is replaced by a signal generator connected with the interrupter. The switching on and off of the internal vibrator then takes place via the signal generator, by supplying the interrupter with an interrupt signal. The interruption of the supply of power to the electric motor thus takes place only at one point, and not, as in known internal vibrators, at two points, namely at the conventional on/off switch and at the bimetallic switch. In this way, the complexity of the internal vibrator can be reduced while maintaining the same level of functionality.

Generalizing the example cited above, it can be stated: because in principle arbitrarily many signal generators can be connected to the electrically controllable interrupter, the functional scope of the internal vibrator can be “arbitrarily” expanded with a minimal additional technical outlay (addition of additional signal generators).

In addition, electrically controllable interrupters, in particular triacs, are more stable mechanically and thermally than are bimetallic switches, because they are not subject to mechanical wear and scaling, and are not influenced in their functioning in the casting together of the components. In this way, there results an internal vibrator that is optimized with respect to the manufacturing process and costs, whose functioning is guaranteed over a long time span.

The interrupt signals that control the interrupter or the interrupter subunits (designated below simply as the interrupter), which signals are produced by signal generators connected to the interrupter, can be divided into internal and external interrupt signals. Preferably, the internal vibrator has at least one internal signal generator that is connected to the interrupter and is integrated into the vibrator housing, each of the internal signal generators being able to produce a corresponding internal interrupt signal, dependent on which the interrupter can be controlled. In addition, in a preferred specific embodiment at least one external signal generator that is connected to the interrupter and is attached outside the vibrator housing is provided, each external signal generator being able to produce a corresponding external interrupt signal, dependent on which the interrupter can be controlled.

An example of an internal signal generator is the temperature monitoring device, already mentioned above, for acquiring the temperature of the electric motor, or in the vibrator bottle. The temperature monitoring device produces, on the basis of the acquired temperature of the electric motor, an internal interrupt signal that is provided to the interrupter (which can also be regarded as a component of the temperature monitoring device). For this purpose, the temperature monitoring device comprises at least one temperature sensor, preferably attached in the immediate vicinity of the electric motor winding head. The temperature fuse based on bimetallic switches is thus replaced by the combination of a temperature sensor with an electrically controllable interrupter.

Another example of an internal signal generator is a voltage-dependent switching element that is connected with the power lead, by means of which a corresponding internal interrupt signal can be produced dependent on the voltage adjacent to the electric motor. For example, the voltage-dependent switching element is constructed in such a way that it registers a failure of the flow of current or of the supply voltage in one of the current conductors, and likewise interrupts the flow of current in the remaining current conductors by producing corresponding internal interrupt signals, in order to avoid a high current loading of the electric motor (2-phase operation). In addition, the voltage-dependent switching element can be designed in such a way that it can be switched dependent on a modulated supply voltage signal. In addition, it would be possible to construct the voltage-dependent switching element in such a way that when excess voltages occur it interrupts the flow of current, or controls the flow of current to values that correspond to the rated values of the internal vibrator.

Another example of an internal and/or external signal generator is a position switch by which a corresponding interrupt signal can be produced dependent on the spatial orientation of the vibrator housing (e.g., in horizontal position): if the internal vibrator is laid on the ground by the operator, the internal vibrator automatically switches itself off.

Further examples of respective internal or external signal generators include light sensors, magnetic sensors, bimetallic switches, ball switches, capacitive and inductive sensors, mercury switches, liquid switches, oil switches having photosensitive relays, radio signal generators, light signal generators, or infrared signal generators. In addition, the signal generators can comprise conductive plastics, reed relays, and the like.

Preferably, an integrated logic circuit is provided that is connected to the interrupter and to internal and/or external signal generators, the integrated logic circuit being able to produce, dependent on a plurality of interrupt signals that are produced by the internal or external generators and are supplied to this circuit, a common interrupt signal (or a plurality of “common” interrupt signals if a plurality of interrupt signal subunits are used) via which the interrupter can be controlled. With the aid of the integrated logic circuit, a large number of different interrupt signals can be evaluated, making possible a simultaneous operation of a large number of different signal generators in a simple manner.

The internal vibrator according to the present invention preferably has the design that has already been described and is shown in FIG. 1. According to this design, a protective tube is provided to whose one end is connected the vibrator housing or the vibrator bottle, and to whose other end is connected, via a coupling piece, another part (leading to a power plug) of the power lead. The coupling piece can be a mounting unit for accommodating a frequency converter, and/or can comprise a switch for switching the electric motor in the vibrator converter, and/or can comprise a switch for switching the electric motor in the vibrator housing.

The integrated logic circuit can here be provided at an arbitrary position in or on the internal vibrator. Preferably, the integrated logic circuit is integrated into the vibrator housing or into the vibrator bottle itself, into the power plug, or into the mounting unit. The integrated logic circuit can for example be constructed together with the interrupter and/or at least a part of the internal signal generator, as a single component.

As already mentioned, an external signal generator may be a signal generator that can be operated by a user (for example, a button or switch), via whose corresponding external interrupt signal the internal vibrator can be switched on and off. The signal generator here is preferably provided at a distance from the vibrator bottle, i.e., for example attached to the end of the protective tube or constructed as a separate remote controller, by means of which the controlling of the internal vibrator can take place via a receptor element attached to the internal vibrator.

These and additional features and advantages of the present invention are explained in more detail below in a specific exemplary embodiment, with reference to the drawings.

FIG. 1 shows a specific embodiment of an internal vibrator according to the prior art;

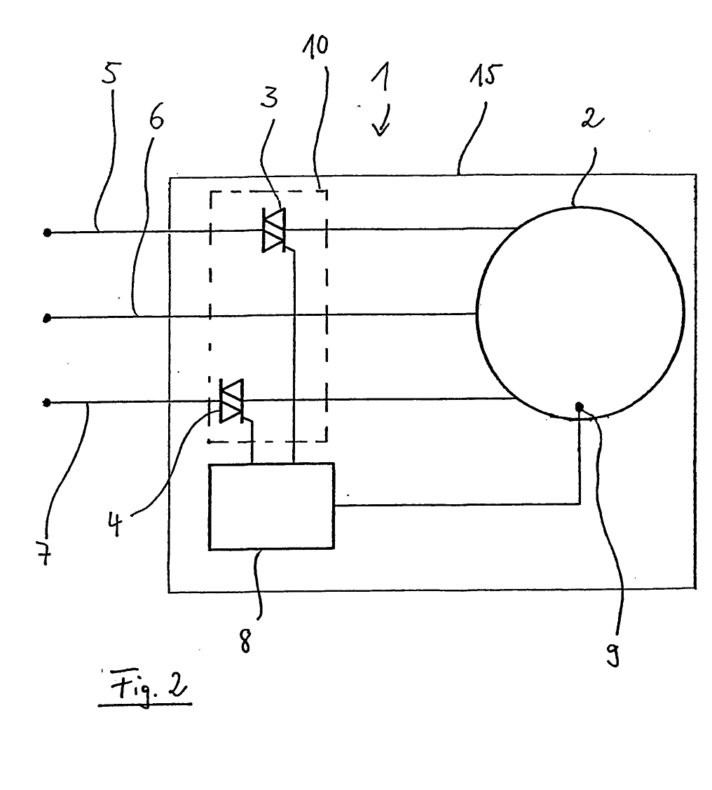

FIG. 2 shows a schematic switching diagram for the illustration of the working together of an interrupter with the internal and/or external signal generators in a first specific embodiment of the present invention;

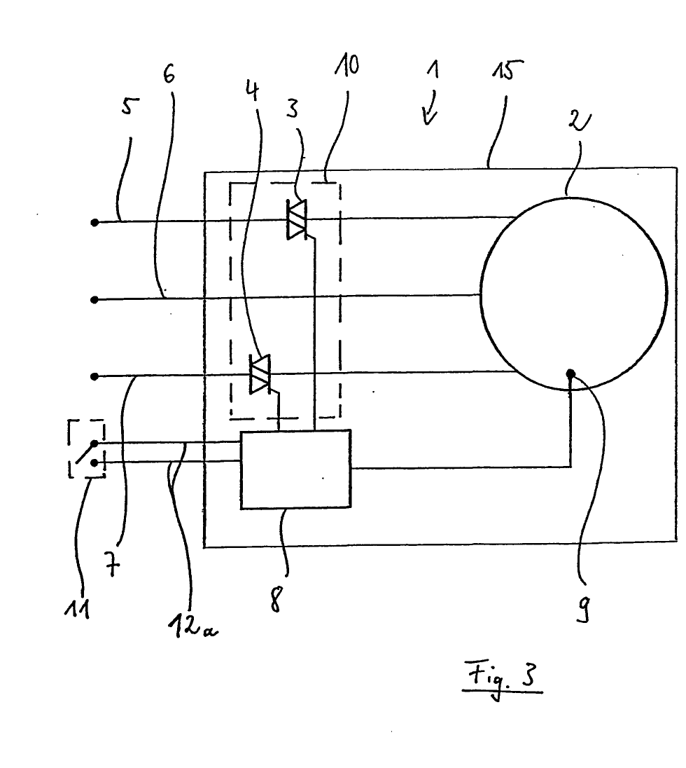

FIG. 3 shows a schematic switching diagram for the illustration of the working together of the interrupter with the internal/external signal generators of an internal vibrator according to the present invention in a second specific embodiment;

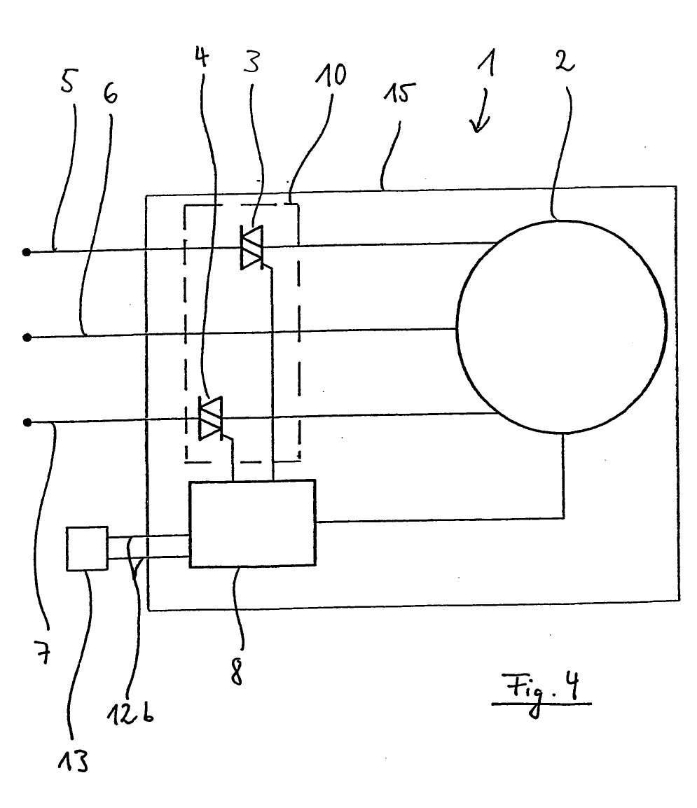

FIG. 4 shows a schematic switching diagram of an internal vibrator according to the present invention in a third specific embodiment;

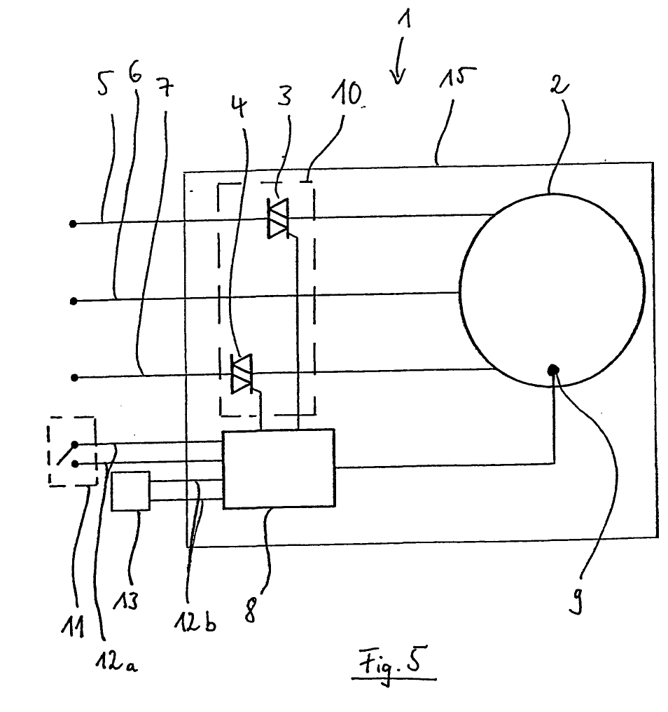

FIG. 5 shows a schematic switching diagram of an internal vibrator according to the present invention in a fourth specific embodiment;

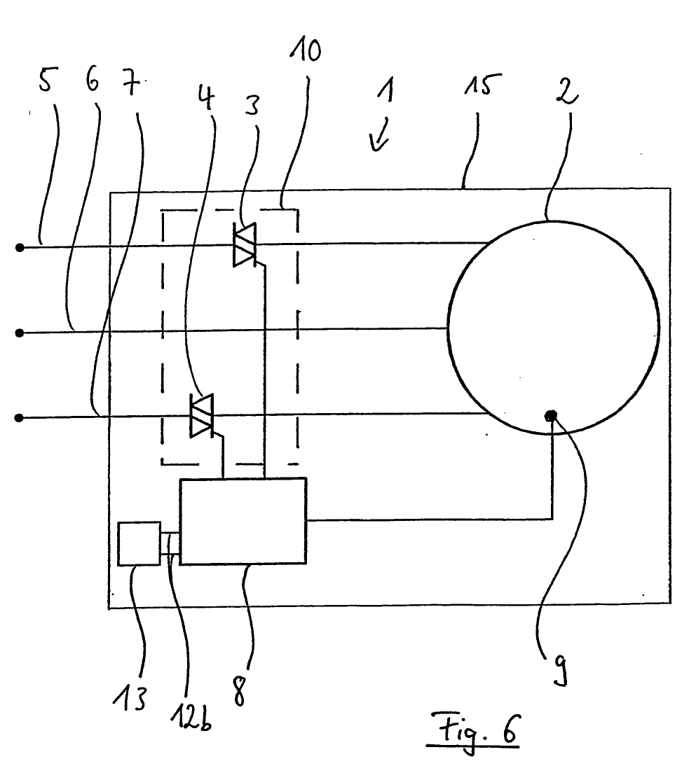

FIG. 6 shows a schematic switching diagram of an internal vibrator according to the present invention in a fifth specific embodiment;

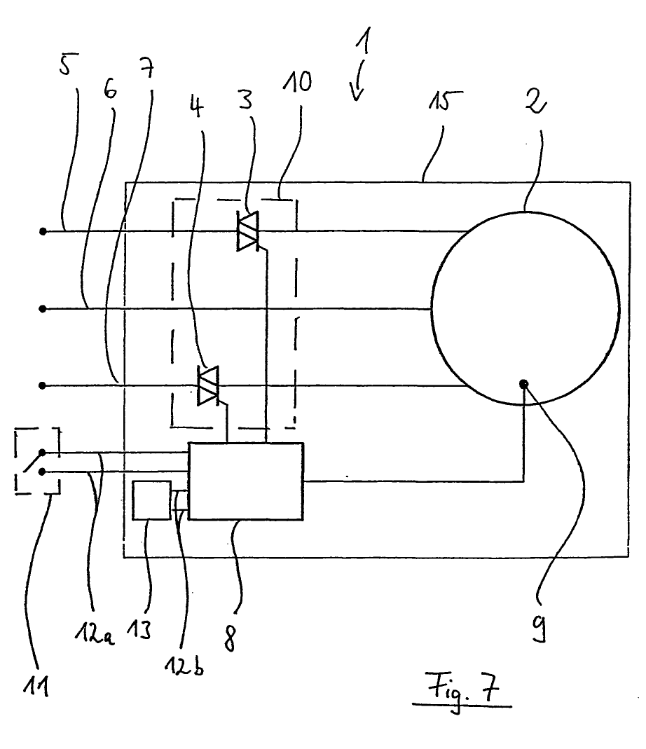

FIG. 7 shows a schematic switching diagram of an internal vibrator according to the present invention in a sixth specific embodiment;

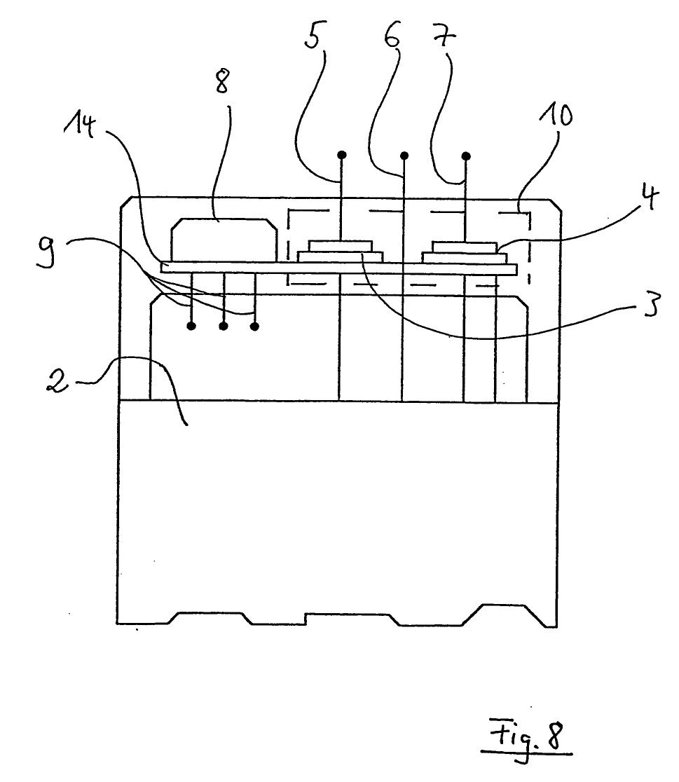

FIG. 8 shows a schematic drawing of the electric motor head in connection with the specific embodiment of the internal vibrator shown in FIG. 2, in a cross-sectional representation. The known specific embodiment of an internal vibrator shown in FIG. 1 has already been described and is therefore not explained in more detail here. In the specific embodiments described below, components corresponding to one another have been identified with the same reference characters.

FIG. 2 shows a schematic switching diagram 1 having an electric motor 2, a first triac 3, a second triac 4, a first current conductor 5, a second current conductor 6, a third current conductor 7, an integrated logic circuit 8, and a temperature sensor 9. All components situated inside the area identified with reference character 15 are to be regarded as integrated into vibrator bottle 21, while all components situated outside area 15 are attached to the internal vibrator outside vibrator bottle 21, or are provided completely separately therefrom.

The three-phase current supplied to electric motor 2 by means of first, second, and third current conductors 5 to 7 can be interrupted by first triac 3, which is inserted into first current conductor 5, and by second triac 4, which is inserted into third current conductor 7. For this purpose, integrated logic circuit 8 simultaneously produces, and supplies to first triac 3 and second triac 4, “common” interrupt signals in the form of a first interrupt signal, to be supplied to first triac 3, and a second interrupt signal, to be supplied to second triac 4. Together, first triac 3 and second triac 4 represent an interrupter 10.

In the place of triacs 3, 4, other electrically controllable interrupters can also be used.

As an internal signal generator, here temperature sensor 9 is provided, which measures the temperature in or on electric motor 2 and, when a determined temperature threshold value is exceeded, supplies a corresponding interrupt signal to integrated logic circuit 8, which, dependent thereon, produces the common interrupt signals. Alternatively, temperature sensor 9 permanently supplies integrated logic circuit 8 with a temperature signal that is evaluated by integrated logic circuit 8.

The specific embodiment shown in FIG. 3 differs from the specific embodiment shown in FIG. 2 only by the addition of an additional first external signal generator 11 that is connected to integrated logic circuit 8 and that supplies to this circuit a corresponding interrupt signal when first external signal generator 11 is actuated. First external signal generator 11 is connected to integrated logic circuit 8 via a signal line 12, which can for example be realized on the basis of a copper or glass fiber cable or a radio transmission. Via first external signal generator 11, interrupter 10 can be controlled independently of temperature sensor 9. External signal generator 11 is preferably fashioned as an on-and-off switch of the internal vibrator.

The specific embodiment shown in FIG. 4 differs from the specific embodiment shown in FIG. 2 by the additional use of a second external signal generator 13, realized here in the form of a position switch. Second external signal generator 13 is connected with integrated logic circuit 8 via a corresponding signal line 12b; when there is a specific spatial (e.g. horizontal) orientation of internal vibrator 20, a corresponding interrupt signal is sent to the internal logic circuit 8, dependent on which signal the integrated logic circuit supplies the common interrupt signals to interrupter 10, or to first triac 3 and second triac 4.

The specific embodiment shown in FIG. 5 represents a combination of the specific embodiments shown in FIGS. 3 and 4. Both first external signal generator 11 and second external signal generator 13 are present. Interrupter 10 is thus able to be controlled by the user himself, both by means of first external signal generator 11 and also using temperature sensor 9 and second external signal generator 13, which is preferably realized as a position switch.

The specific embodiment shown in FIG. 6 differs from the specific embodiment shown in FIG. 4 only in that second external signal generator 13 (position switch) is here fashioned as an internal signal generator, i.e., is integrated into vibrator housing 21a.

The specific embodiment shown in FIG. 7 differs from the specific embodiment shown in FIG. 5 in that here, as in the specific embodiment according to FIG. 6, second external signal generator 13 (position switch) is fashioned as an internal signal generator.

In FIG. 8, it can be seen how temperature sensors 9, integrated logic circuit 8, and interrupter 10 consisting of first triac 3 and second triac 4, can be fashioned as a common component. For this purpose, all components are mounted on a common circuit board 14.

Even if, in the specific embodiments described above, one or more temperature sensors are always specified as internal signal generators, in other specific embodiments of the present invention other types of internal signal generators (e.g. position switches, speed counters, etc.) are also provided, as are specific embodiments having only external signal generators.

1. An internal vibrator (20) for compacting concrete, having a vibrator housing (21a) into which are integrated
an imbalance mass capable of being rotated,
an electric motor (2) that drives the imbalance mass, and
a part of a power lead (5,6,7,26), connected to the electric motor (2), for supplying power to the electric motor (2), and having
an electrically controllable interrupter (3,4,10) inserted into the power lead (5,6,7,26) for the interruption of the supply of power to the electric motor (2), characterized in that the interrupter (3,4,10) is integrated into the vibrator housing (21a).

2. The internal vibrator (20) as recited in claim 1, characterized in that the interrupter (3,4,10) comprises at least one triac (3,4).

3. The internal vibrator (20) as recited in claim 1 or 2, characterized by at least one internal signal generator (9, 13) that is connected with the interrupter (3,4,10) and is integrated into the vibrator housing (21a), each of the internal signal generators (9, 13) being capable of producing a corresponding internal interrupt signal, dependent on which the interrupter (3,4,10) can be controlled.

4. The internal vibrator (20) as recited in one of the preceding claims, characterized by at least one external signal generator (11, 13) that is connected to the interrupter (3,4,10) and is attached outside the vibrator housing, each of the external signal generators (11, 13) being capable of producing a corresponding external interrupt signal, dependent on which the interrupter (3,4,10) can be controlled.

5. The internal vibrator (20) as recited in claim 3 or 4, characterized in that the internal signal generator is a temperature monitoring device (9) connected with the interrupter (3,4,10) for acquiring a temperature in the vibrator housing (21a), and that the interrupter (3,4,10) can be controlled dependent on an internal interrupt signal that is based on the acquired temperature and that can be produced by the temperature monitoring device (9).

6. The internal vibrator (20) as recited in claim 3 or 4, characterized in that the internal signal generator is a voltage-dependent switching element that is connected to the interrupter (3,4,10) and to the power lead (5,6,7,26), and that a corresponding internal interrupt signal can be produced dependent on the voltage adjacent to the electric motor (2).

7. The internal vibrator (20) as recited in one of claims 3 to 6, characterized in that the internal and/or external signal generator is a position switch (13) that can produce, dependent on the spatial orientation of the vibrator housing (21a), a corresponding interrupt signal.

8. The internal vibrator (20) as recited in one of claims 3 to 7, characterized in that respective internal signal generators (9, 13) and/or external signal generators (11) comprise light sensors, magnetic sensors, bimetallic switches, ball switches, capacitive and inductive sensors, mercury switches, liquid switches, oil switches having photosensitive relays, radio signal generators, light signal generators, or infrared signal generators.

9. The internal vibrator (20) as recited in one of claims 3 to 8, characterized by an integrated logic circuit (8) that is connected to the interrupter (3,4,10) and to respective internal signal generators (9, 13) and/or to respective external signal generators (11), such that the integrated logic circuit (8) is able to produce, dependent on a plurality of interrupt signals that are produced by the internal or external generators (11) and are supplied to this circuit, a common interrupt signal by which the interrupter can be controlled.

10. The internal vibrator (20) as recited in claim 9, characterized in that the external interrupt signal can be transmitted to the interrupter (3,4,10) or to the integrated logic circuit (8) by the external signal generator (11) via radio, infrared light, cable, or light wave conductors, and, if necessary, via a receptor element provided on the interrupter (3,4,10).

11. The internal vibrator (20) as recited in one of the previous claims, characterized by a protective tube (23) to whose one end the vibrator housing (21a) is attached and to whose other end there is attached, via a coupling piece, another part, leading to a power plug (27), of the power lead (26).

12. The internal vibrator as recited in claim 11, characterized in that the coupling piece is a mounting unit (24) for accommodating a frequency converter.

13. The internal vibrator (20) as recited in claim 11 or 12, characterized in that the external signal generator is a signal generator (11) that can be operated by a user, by which a corresponding external interrupt signal can be produced, so that the internal vibrator (20) can be switched on and off, the external signal generator (11) being provided at a distance from the vibrator housing (21), in particular on the protective tube (23) of the internal vibrator (20), in the mounting unit (24), or as a separate remote controller.

14. The internal vibrator (20) as recited in one of the preceding claims, characterized in that the integrated logic circuit (8) is integrated into the vibrator housing (21a).

15. The internal vibrator (20) as recited in one of claims 11 to 13, characterized in that the integrated logic circuit (8) is integrated into the power plug (27).

16. The internal vibrator (20) as recited in one of claims 11 to 13, characterized in that the integrated logic circuit (8) is integrated into the mounting unit (24).
